(19) United States
(12) Patent Application Publication
(10) Pub. No.: US 2007/0299642 A1
(43) Pub. Date: Dec. 27, 2007

(54) Apparatus and method for verifying control program through simulation

(75) Inventor: Koichi Kondo, Kawasaki-shi (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 11/812,306

(22) Filed: Jun. 18, 2007

(30) Foreign Application Priority Data
Jun. 27, 2006 (JP) P2006-176989

(51) Int. Cl. G06G 7/48

(52) U.S. Cl. 703/6

(57) ABSTRACT

A simulation apparatus includes a workpiece state data storage section for storing a plurality of pieces of workpiece state data associating workpiece states and solids with each other and transition condition data representing a transition condition among workpiece states, a dynamics simulator 205 for executing dynamics simulation along the time base based on dynamics model data, a state transition event detection section for detecting occurrence of a workpiece state transition event, a relative position calculation section for calculating data representing the relative positional relationship between the workpiece state and the solid associated with the workpiece state at the occurrence time of an event, and a constraint relationship data generation section for generating data representing the workpiece constraint relationship based on the positional relationship data and assembly model data.

### RELATED APPLICATION(S)

The present disclosure relates to the subject matter contained in Japanese Patent Application No. 2006-176989 filed on Jun. 27, 2006, which is incorporated herein by reference in its entirety.

### FIELD

The present invention relates to a simulation apparatus, a simulation method, and a simulation program suited to be used for a simulation system for verifying a control program for a mechatronics system, using a simulator without connecting the control program to an actual machine to be controlled.

### BACKGROUND

Known as an assembly model generation method in a related art is a method of automatically setting the additional geometrical constraint relationship and its associated mechanism parameter required for use for a kinematics analysis and a motion planning in an assembly model and executing the kinematics analysis and the motion planning intact. (For example, refer to Japanese Patent No. 3643504.) A simulation data generation method for easily generating simulation data to simulate the dynamic behavior of a system over time without performing edit work on the text basis is proposed. (For example, refer to JP-A-2002-140653.) Further, a simulation method of simulating the behavior of the target mechanism along the time base using a hybrid model is proposed. (For example, refer to JP-A-2004-178300, counterpart U.S. publication of which is US 2004/0158442 A1.) As for the hybrid model, a technique of representing a system as ordinary differential simultaneous equations using a hybrid modeling language is known. (For example, refer to related-art document 1, which is listed below.) As for design of firmware of a mechatronics system, a technique of reducing backtracking of design by check, etc., by simulating the specifications at an upstream stage is proposed. (For example, refer to related-art document 2, which is listed below.)

Related-art document 1: “Use of Hybrid Models for Testing and Debugging Control Software for Electromechanical Systems,” IEEE/ASME Trans. Mechatronics, Vol. 10, No. 3, June 2005, pp. 275-284

Related-art document 2: KONDO Koichi, HOSHINO Susumu, MOTOHASHI Shoichi: “Simulation-Based Process Innovation of Firmware Development for Electromechanical Products,” Toshiba Review, Vol. 60, No. 1, 2005

A workpiece needs to be handled generally in a system including a manufacturing apparatus and a robot built in the manufacturing apparatus as a robot handles a workpiece of a silicon wafer in a semiconductor manufacturing apparatus, for example.

As an example close to the situation, in simulation using a mechatronics system such as a copier or a printer, since the paper transport passage is one-dimensional, a move distance is given, whereby simulation is executed to find the paper position in the machine. Then, at the mechanism definition stage, the control software engineer previously defines a behavior model of paper and contains the defined behavior model in a data file and then connects control software to a simulator according to the same procedure as connecting to an actual machine and verifies the connected control software.

However, in workpiece handling, a simulation apparatus cannot determine in advance what state will be entered at the next step according to motion of a robot and a transporter. In addition, for example, for the operation of a robot to place a workpiece on a bed, the simulation apparatus cannot determine in advance the workpiece will be placed on the bed at what position and orientation.

### SUMMARY

According to a first aspect of the invention, there is provided a simulation apparatus for verifying a control program used for controlling a machine available with workpiece handling operation by simulating the machine. The apparatus includes: a dynamics model data storage section that stores dynamics model data of the machine; an assembly model data storage section that stores assembly model data about a mechanism model of the machine; a workpiece state data storage section that stores a plurality of pieces of workpiece state data associating each of a plurality of workpiece states with a solid, and transition condition data representing a transition condition among the workpiece states; a dynamics simulator that executes dynamics simulation over time based on the dynamics model data in accordance with a control command output from the control program; a state transition event detection section that detects occurrence of a workpiece state transition event; a relative position calculation section that calculates positional relationship data representing the relative positional relationship between the workpiece state of the workpiece and the solid associated with the workpiece state at a time when a state transition event occurs based on the plurality of pieces of workpiece state data; and a constraint relationship data generation section that generates data representing the workpiece constraint relationship based on the positional relationship data and the assembly model data.

According to a second aspect of the invention, there is provided a simulation method for verifying a control program used for controlling a machine available with workpiece handling operation by simulating the machine. The method includes: reading assembly model data about a mechanism model of the machine, dynamics model data of the machine, a plurality of pieces of workpiece state data associating a plurality of workpiece states and a solid with each other, and transition condition data representing a transition condition among the workpiece states; reading a control command from the control program; executing dynamics simulation based on the dynamics model data; determining occurrence of a workpiece state transition event based on data of the mechanism model, data to determine the presence or absence of interference between the machine and a substance, and a variable of a dynamics model of the machine; calculating positional relationship data representing the relative positional relationship between the workpiece state of the workpiece and the solid associated with the workpiece state at the occurrence time of the state transition event, when a state transition event occurs; and generating data representing the workpiece constraint relationship based on the positional relationship data and the assembly model data.

According to a third aspect of the invention, there is provided a computer readable medium storing a program causing a computer to execute a process for verifying a control program used for controlling a machine available with workpiece handling operation by simulating the machine. The process includes: reading assembly model data about a mechanism model of the machine, dynamics model data of the machine, a plurality of pieces of workpiece state data associating a plurality of workpiece states and a solid with each other, and transition condition data representing a transition condition among the workpiece states; reading a control command from the control program; executing dynamics simulation based on the dynamics model data; determining occurrence of a workpiece state transition event based on data of the mechanism model, data to determine the presence or absence of interference between the machine and a substance, and a variable of a dynamics model of the machine; calculating positional relationship data representing the relative positional relationship between the workpiece state of the workpiece and the solid associated with the workpiece state at the occurrence time of the state transition event, when a state transition event occurs; and generating data representing the workpiece constraint relationship based on the positional relationship data and the assembly model data.

### BRIEF DESCRIPTION OF THE DRAWINGS

In the accompanying drawings:

FIG. 1 is a drawing to show a configuration example of a simulation system according to an embodiment of the present invention;

FIG. 2 is a block diagram of a simulation apparatus according to the embodiment;

FIG. 3 is a flowchart to describe a simulation method according to the embodiment;

FIG. 4 is a drawing to schematically show component parts of an assembly model;

FIG. 5 is a drawing to schematically show the relationship between geometric features of parts and the constraint relationship among the geometric features;

FIG. 6 is a drawing to describe a representation method using an algebraic equation of geometrical constraint;

FIG. 7 is a drawing to describe degrees of freedom in the constraint relationship defined among parts;

FIG. 8 is a drawing to show examples of geometric features representing parameters for defining degrees of freedom of mechanism;

FIG. 9 is a drawing to schematically show the relationship among geometric features of parts, the constraint relationship among the geometric features, and new constraint relationships;

FIG. 10 is a drawing to show the initial state of a workpiece in simulation involving handling;

FIG. 11 is a drawing to show a state in which the workpiece is grabbed by a hand;

FIG. 12 is a drawing to show a state in which the workpiece is on a parts pallet;

FIG. 13 is a drawing to show a state in which the workpiece and the parts pallet are in one piece;

FIG. 14 is a drawing to show an example of the simulation result of a DC motor model represented as a hybrid model;

FIG. 15 is a drawing to show the initial state of an air actuator and a differential equation corresponding to the initial state;

FIG. 16 is a drawing to show a state when a reaction force of a spring of the air actuator occurs and a differential equation corresponding to the state;

FIG. 17 is a drawing to show a state in which a right-direction force is exerted on a piston of the air actuator and a differential equation corresponding to the state;

FIG. 18 is a drawing to show a state in which a left-direction force is exerted on the piston of the air actuator and a differential equation corresponding to the state;

FIG. 19 is a drawing to describe the state transition of the air actuator;

FIG. 20 is a drawing to describe the state transition of the air actuator in a simple manner;

FIG. 21 is a drawing to show a program example of a hybrid constraint programming language corresponding to FIG. 20; and

FIG. 22 is a drawing to show an example of the internal representation of a state transition condition in a workpiece state retention section.

### DETAILED DESCRIPTION OF THE EMBODIMENTS

A simulation apparatus and a simulation method and a simulation program used with the simulation apparatus according to an embodiment of the present invention will be discussed with reference to the accompanying drawings. Identical parts in the accompanying drawings are denoted by the same reference numerals and duplicate description will be omitted.

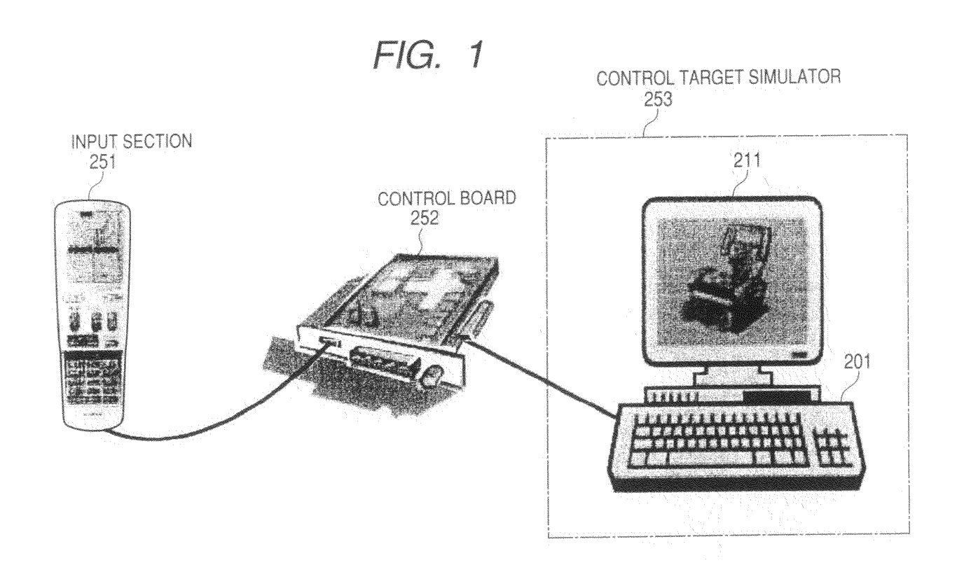

A simulation system according to the embodiment of the invention verifies a control program using a control target simulator and includes an input section (input unit) 251, a control board 252, and a control target simulator 253 as shown in FIG. 1. The input section 251 allows an operator (a control software engineer) to enter an operation command in the control board 252; for example, a remote control is used. The control board 252 is a unit for inputting a control command to the control target simulator 253. ROM storing a control program and an LSI for hardware control are installed in the control board 252, and software (also called firmware) verified by the simulation method according to the embodiment is executed.

The control target simulator 253 is a simulation apparatus for using a control program for a mechatronics system such as a robot containing the workpiece handling operation as a control target to simulate the mechatronics system, thereby verifying the control program; it simulates motion of a robot for handling a wafer as a workpiece and the operation of an actuator, such as a motor, attached to a joint of the robot. The control target simulator 253 simulates motion of a robot including the workpiece handling operation. It is provided with a display section (display) 211 implemented as a personal computer display for displaying the simulation situation.

The control software engineer connects the control target simulator 253 to the control board 252 on which firmware is installed instead of connecting an actual machine. Accordingly, the firmware on the control board 252 is executed based on an operation command from the input section 251 and a control command, such for motor stop or start, is sent from the control board 252 to the control target simulator 253. Motion of the actual machine to be controlled (control target) is displayed on the display section 211 using computer graphics.

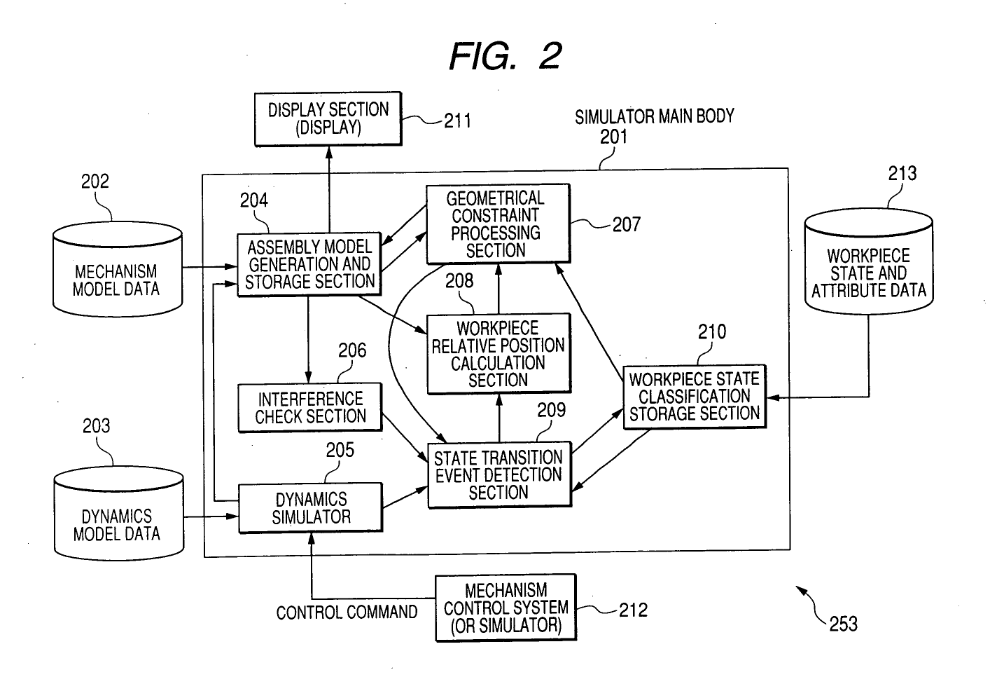

As shown in FIG. 2, the control target simulator 253 includes a simulator main body 201, a mechanism model data storage section 202, a dynamics model data storage section 203, and a workpiece state and attribute data storage section 213. The simulator main body 201 is connected to a mechanism control system (or simulator) 212 for outputting a control command. The mechanism control system 212 corresponds to the input section 251 and the control board 252 shown in FIG. 1.

The mechanism model data storage section 202 stores robot assembly model data that includes: data representing the shapes of a plurality of parts; and data representing the constraint relationship among a plurality of parts.

The dynamics model data storage section 203 is a dynamics model data storage section for storing dynamics model data of the dynamic characteristic of the drive system of a robot. It stores dynamics model data of a hybrid model including a plurality of, two for example, dynamics models.

The workpiece state and attribute data storage section 213 stores a plurality of pieces of workpiece state data associating a workpiece state and a solid with each other and transition condition data representing a transition condition among a plurality of workpiece states. The attribute data stored in the workpiece state and attribute data storage section 213 refers to the state transition condition data to stop interference check processing for detecting a collision or contact between a robot and a substance grabbed by the robot, an obstacle, etc. The dynamics model data storage section 203 according to the embodiment references the attribute data, thereby detecting interference, for example, if two substances placed at a distance from each other are piled by handling of the robot. After the two substances are piled, the dynamics model data storage section 203 stops the interference check processing, thereby decreasing the calculation amount.

The mechanism model data storage section 202, the dynamics model data storage section 203, and the workpiece state and attribute data storage section 213 are implemented each as storage device and can use a hard disk incorporated in or an additional hard disk to a personal computer or the like. The mechanism model data storage section 202, the dynamics model data storage section 203, and the workpiece state and attribute data storage section 213 can use storage media such as a CD or a DVD onto which data can be written or small-sized memory that can be inserted and removed from the simulator main body 201 or may be integrated with the simulator main body 201 or may be able to be detached from the simulator main body 201.

The simulator main body 201 includes a dynamics simulator 205, an assembly model generation and storage section (assembly model storage section) 204, an interference check section 206, a state transition event detection section 209, a workpiece relative position calculation section 208, a geometrical constraint processing section 207, and a workpiece state classification storage section (workpiece state storage section) 210.

The dynamics simulator 205 executes dynamics simulation over time based on the dynamics model data of robot in accordance with a control command from a control program. That is, the dynamics simulator 205 previously reads the dynamics model data and executes dynamics simulation while reading a control command from a control program every cycle time during the simulation execution. The dynamics simulator 205 executes simulation in accordance with a plurality of dynamics models of a robot described according to a hybrid model and if occurrence of a state transition event is detected, the dynamics simulator 205 switches the plurality of dynamics models. The dynamics simulator 205 also functions as a dynamics model variable acquisition section for acquiring variables of dynamics models of a robot.

The assembly model generation and storage section 204 is an assembly model data storage section for storing assembly model data about a mechanism model of a robot. The assembly model generation and storage section 204 previously reads the mechanism model data in the mechanism model data storage section 202, generates assembly model data, and stores the generated assembly model data. The assembly model generation and storage section 204 has a function of acquiring the values of the angle of a specified joint, etc., and also functions as a mechanism model data acquisition section for acquiring the value of the angle of a joint, etc., as mechanism model data of a robot.

Hereinafter, the function of acquiring the values of the angle of a specified joint, etc., will be referred to as mechanism model analog sensor, because the value of the angle of a joint, etc., is reference to an analog value such as the angle of a specified joint or the distance between two geometrical elements between specified same or different kinds. A physical sensor is not required for this function.

The interference check section 206 determines the presence or absence of interference between a robot and a substance like a situation in which the left or right hand of a robot comes in contact with a parts transport passage, and functions as an interference presence/absence determination section. The interference check section 206 has a function of specifying two solids and examining the presence or absence of interference between the specified solids (hereinafter, the function will be referred to as interference check sensor. A physical sensor is not required for this function), and the function references the assembly model generation and storage section 204 and determines the presence or absence of interference of a geometrical shape. Any of proposed and already existing various techniques can be used as an interference check algorithm used with the interference check section 206.

The state transition event detection section 209 detects occurrence of a workpiece state transition event and determines whether or not a transition is to be made to the workpiece state stored in the workpiece state classification storage section 210. The state transition event detection section 209 according to the embodiment references the mechanism model analog sensor, the interference check sensor, and the dynamics model variable and evaluates one of the data provided by the mechanism model analog sensor, the presence or absence of interference based on the interference check sensor, and the dynamics model variable value or all of them in combination in the form of a Boolean expression, thereby determining the transition condition.

The workpiece relative position calculation section 208 calculates positional relationship data representing the relative positional relationship between the workpiece state and the solid associated with the workpiece state at the occurrence time of a state transition event based on a plurality of pieces of workpiece state data, and functions as a relative position calculation section. That is, the workpiece relative position calculation section 208 calculates the relative positional relationship of the workpiece when a transition is made from one workpiece state to another.

The geometrical constraint processing section 207 is a constraint relationship data generation section for generating data representing the workpiece constraint relationship based on the positional relationship data and assembly model data. The geometrical constraint processing section 207 references the assembly model generation and storage section 204 and performs processing of geometrical constraint.

The workpiece state classification storage section 210 is a workpiece state data storage section for storing a plurality of pieces of workpiece state data associating workpiece states and solids with each other and transition condition data representing a transition condition among workpiece states. The workpiece state classification storage section 210 previously classifies the states that a workpiece can take according to what a workpiece is grabbed by as the workpiece is grabbed by the left hand or the right hand of a robot, etc., and stores the classified workpiece states.

The functions of the state transition event detection section 209, the workpiece relative position calculation section 208, the geometrical constraint processing section 207, and the workpiece state classification storage section 210 are implemented as a CPU (central processing unit), ROM, RAM, an IC, an LSI, a hard disk, etc.

Accordingly, in the simulation method, first the control target simulator 253 reads the assembly model data, the dynamics model data, a plurality of pieces of workpiece state data associating workpiece states and solids with each other, and transition condition data representing a transition condition among workpiece states about the mechanism model of a robot. The control target simulator 253 reads a control command from a control program and then executes dynamics simulation based on the dynamics model data. It determines occurrence of a workpiece state transition event based on the analog data of the mechanism model analog sensor, the value of the interference check sensor, and the variable value of the dynamics model. If a state transition event occurs, the control target simulator 253 calculates the relative positional relationship data between the workpiece at the occurrence time of the state transition event and the solid associated with the workpiece. It generates data representing the workpiece constraint relationship based on the positional relationship data and the assembly model data.

The simulation system according to the embodiment can also retain a program for causing a computer such as a personal computer to execute the simulation method of the invention. The computer reads the program, whereby the control target simulator 253 is caused to execute processing. The control target simulator 253 can retain the program on a hard disk or various storage media that can be detached from the personal computer. In so doing, the program for causing a computer to execute the simulation method according to the embodiment can be easily retained, transported, sold, or the like.

In the simulation system according to the embodiment, while the convenience for the control software engineer to be able to connect the mechanism control system 212 wherein control software is installed to the simulator main body 201 according to the same procedure as connecting to an actual machine and verify the control software is ensured, the control target simulator 253 reads control target model data previously generated by a machine engineer, whereby a state in which simulation can be executed is entered. The control target model data refers to the data stored in the mechanism model data storage section 202, the dynamics model data storage section 203, and the workpiece state and attribute data storage section 213.

Specifically, the mechanism model data refers to data containing shape data in a three-dimensional space of the parts making up a machine such as a robot and data of a model provided by combining the parts.

The dynamics model data refers to data of a model concerning the dynamic characteristic of an actuator of a motor, etc. The dynamics model data storage section 203 stores the time-varying situation of the motor speed as data of a differential equation, etc., for example, and the dynamics simulator 205 performs processing of executing numerical integration of the data of the differential equation, etc., whereby the behavior of a robot is represented. More particularly, the dynamics model data is provided for determining the state of the presence or absence of a collision in a three-dimensional space as to what shape the joint becomes when the joint angle of the robot is 45 degrees or 90 degrees at any timing, whether or not a collision between a parts supply bed and an arm occurs when the joint angle is 45 degrees or 90 degrees, or the like. The dynamics model data is also used to verify the time delay responsive to the weight of a workpiece and verify the position, the attitude, and the speed of parts such as the attitude of an air actuator at one moment and time variation of the arm attitude.

The workpiece state and attribute data is data peculiar to the invention; the states that a workpiece can take are enumerated based on “what solid the workpiece relates to” and conditions to make a transition to the state are described for each state. For example, the workpiece state and attribute data is enumerated so as to specify the solid with which the workpiece is associated from the viewpoint of whether or not the workpiece “is grabbed with a robot hand” or “is placed on a bed.” The geometrical positional relationship between the workpiece and its associated party (robot hand, bed, etc.,) cannot previously be determined, but the control target simulator 253 according to the embodiment defines the geometrical positional relationship between the workpiece and its associated party and thus the workpiece state and attribute data storage section 213 need not store the geometrical positional relationship data.

The operation of the simulation apparatus of the invention will be discussed according to the described configuration.

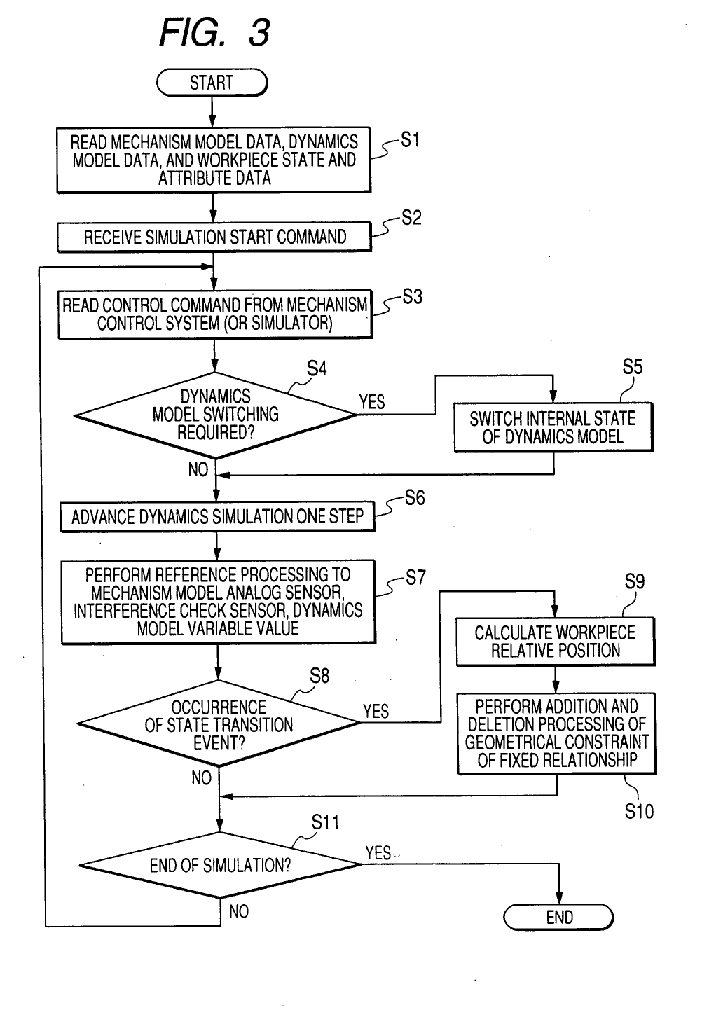

As shown in FIG. 3, at step S1 before simulation execution, the assembly model generation and storage section 204 reads mechanism model data and stores assembly model data generated from the mechanism model data. The mechanism model data is referenced by the geometrical constraint processing section 207 and the interference check section 206 in simulating a geometrical mechanism. The assembly model processing procedure of the geometrical constraint processing section 207 is described later. At step S1, the dynamics data is also read before simulation execution starts, and is stored in the dynamics simulator 205 for use in dynamics simulation of an actuator.

At step S2, the simulator main body 201 receives a simulation start command from the mechanism control system 212.

At step S3, the dynamics simulator 205 receives a control command sent from the mechanism control system 212. When simulation is started, it is executed using only control commands sent from the mechanism control system 212 as data received from the outside. In the simulation system according to the embodiment, the system state is changed in response to a control command from the mechanism control system 212. The simulation model according to the embodiment includes an air actuator having a valve, a spring, and a piston. The simulation model is a continuous system model that can be represented by an ordinary differential equation series; the air flow in the air actuator can be selected from the right or left direction with occurrence of an event and a hybrid model wherein a model representing expression can be replaced is adopted.

Thus, at step S4, the dynamics simulator 205 determines whether or not the internal state of the dynamics model needs to be switched. If the internal state does not correspond to the dynamics model, the dynamics simulator 205 passes through the NO route and goes to step S6. If the internal state corresponds to the dynamics model at step S4, the dynamics simulator 205 passes through the YES route and switches the internal state of the dynamics model at step S5 and then goes to step S6. How the behavior of the actuator is simulated according to the hybrid model is described later.

The simulation according to the embodiment is executed by advancing the time every predetermined time difference Δt such as the sampling time along the time base. At step S6, the dynamics simulator 205 calculates the joint angle, etc., by performing numerical integration processing, for example, based on the characteristic of the motor. When the dynamics simulator 205 advances the time one step (Δt), the state transition event detection section 209 is started every Δt.

At step S7, the state transition event detection section 209 references the state transition condition stored for each workpiece state stored in the workpiece state classification storage section 210. The state transition event detection section 209 references the dynamics simulator 205 in response to the description of the state transition condition and executes acquisition processing of the value of the specified variable, starts the interference check section 206 to execute inquiry processing about the presence or absence of interference, or accesses the geometrical constraint processing section 207 and executes acquisition processing of the value of the angle of the specified joint, etc.

Hereinafter, for convenience of the description, referencing the dynamics simulator 205 and execution of acquisition processing of the value of the specified variable will be referred to as “reference to the dynamics model variable value.” Starting the interference check section 206 to execute inquiry processing about the presence or absence of interference will be referred to as “reference to the interference check sensor.” The reference to the interference check sensor contains not only check processing of geometrical interference between actual solids, but also the operation of previously defining the light beam of a photosensor as a three-dimensional shape and checking whether the photosensor is on or off to examine the presence or absence of geometrical interference between the beam shape and the shape of any other solid. Accessing the geometrical constraint processing section 207 and execution of acquisition processing of the value of the angle of the specified joint, etc., will be referred to as “reference to the mechanism model analog sensor (mechanism model analog value sensor)” because of reference to an analog value such as the angle of the specified joint or the distance between two geometrical elements between specified same or different kinds.

At step S8, further, based on the execution result of each of the reference to the dynamics model variable value, the reference to the interference check sensor, and the reference to the mechanism model analog sensor, the state transition event detection section 209 evaluates a Boolean expression including the values or the execution results in combination and determines whether or not a state transition event occurs.

If occurrence of a state transition event is detected at step S8, the state transition event detection section 209 passes through the YES route and goes to step S9. Since the solid to move in one piece with the workpiece in the state corresponding to the state transition event is stored in the workpiece state classification storage section 210, at step S9, the state transition event detection section 209 starts the workpiece relative position calculation section 208, which then calculates the workpiece relative position.

Further, at step S10, the workpiece relative position calculation section 208 starts the geometrical constraint processing section 207, which then references the workpiece state classification storage section 210 and defines the geometrically fixed relationship according to the solid to be moved in one piece with the workpiece and to the positional relationship at the timing at which the state transition event occurred. The geometrical constraint processing section 207 also deletes redundant geometrical relationship at step S10. In other words, the workpiece relative position calculation section 208 calculates the relative positional relationship with the solid with which the workpiece is associated (step S9) and the geometrical constraint processing section 207 defines the geometrically fixed relationship based on the relative positional relationship of the calculation result (step S10).

Accordingly, as the assembly model, a new relationship is defined and a different behavior is indicated and the workpiece handling operation is reproduced. When the definition processing of the new geometrical relationship, etc., (step S10) terminates or when it is not determined at step S8 that a state transition event occurs (NO route), the display section 211 displays the assembly (mechanism model) state by computer graphics. Accordingly, the control software engineer verifies how the workpiece moves on the time base about motion as to what place the workpiece moves to, etc., or the position, the attitude, and the speed of parts at any desired time and the relative relationship among the parts, etc., when the time is shifted.

At step S11, the dynamics simulator 205 determines whether or not the time reaches a predetermined simulation time. If the time does not reach the end time, the dynamics simulator 205 passes through the NO route and goes to processing of further advancing the time Δt. If the dynamics simulator 205 determines at step S11 that the time reaches the predetermined simulation time, it passes through the YES route and terminates the simulation. Meanwhile, simulation during the sampling time Δt is performed and until the end time is reached or the operator performs simulation interruption operation, the simulation is executed.

Thus, the invention enables the control software engineer to connect the control software to the simulator according to the same procedure as connecting to an actual machine and verify the control software and also makes it possible to simulate a machine system containing workpiece handling while ensuring the convenience.

The processing of the processing sequence described above will be discussed below in more detail.

### (A) Assembly Model Representation and Generation Methods

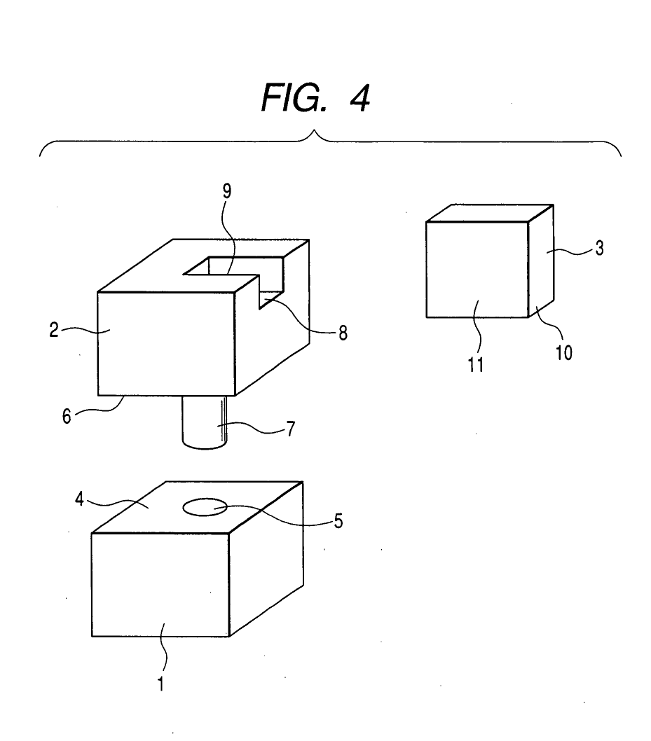

The assembly model representation and generation methods in the assembly model generation and storage section 204 according to the embodiment can use the concept described in Japanese Patent No. 3643504 “Assembly model generation method and record medium recording an assembly model generation processing program” filed by the present inventor, for example. In the description to follow, the case where an assembly model including parts 1, 2, and 3 as shown in FIG. 4 is generated is taken as an example. The simulation system according to the embodiment reads the shape data of the parts 1, 2, and 3 from a file using an input unit of a computer, for example, and stores the data in storage. At this time, the read parts are displayed on the display section 211, for example, as shown in FIG. 4.

If the relationship to be input exists about the relationship among geometric features, the geometric features and their relationship are input using the input unit and are stored in the storage. For example, to generate an assembly model from the parts 1, 2, and 3 shown in FIG. 4, the relationship that a plane 4 of a geometric feature of the part 1 and a plane 6 of a geometric feature of the part 2 match and the relationship that a cylindrical surface 5 of a geometric feature of the part 1 and a cylindrical surface 7 of a geometric feature of the part 2 are coaxial are input as for the parts 1 and 2. Likewise, the relationship that a plane 8 of a geometric feature of the part 2 and a plane 10 of a geometric feature of the part 3 are coplanar and the relationship that a plane 9 of a geometric feature of the part 2 and a plane 11 of a geometric feature of the part 3 are coplanar are input as for the parts 2 and 3.

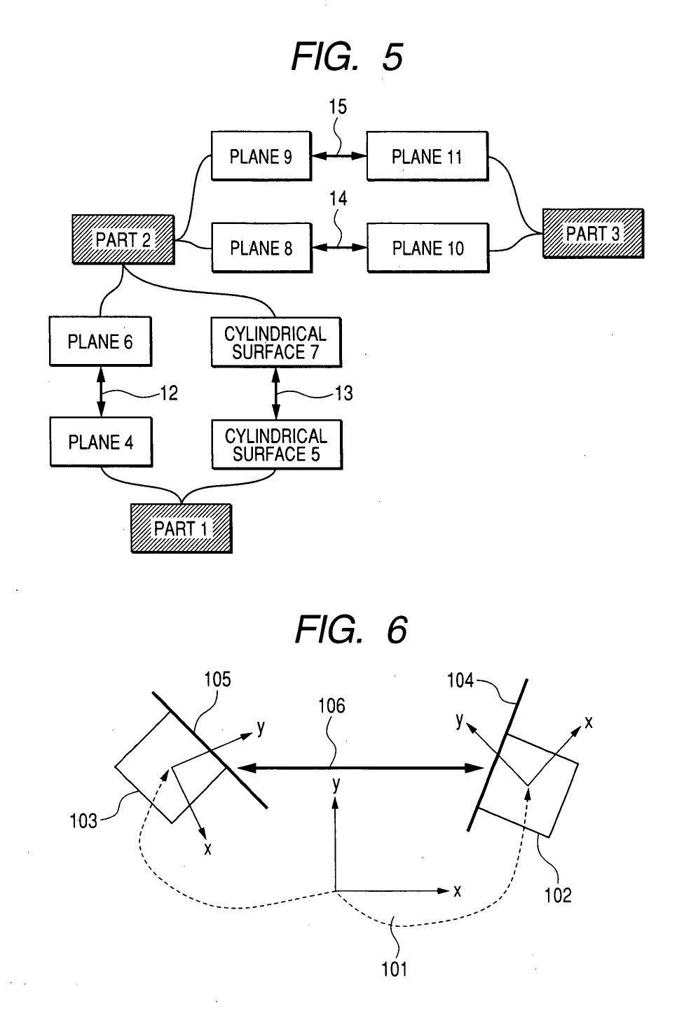

FIG. 5 shows an example to schematically show how the relationships thus input are stored in the storage. As seen in FIG. 5, in addition to information of the parts 1, 2, and 3 and information of the geometric features, coplanar relationships between the planes, 12, 14, and 15, and coaxial relationship between the cylinders, 13, exist as data in the storage.

Next, the workpiece relative position calculation section 208 (FIG. 2) calculates the relative positional relationship among the parts 1, 2, and 3 based on the information stored in the storage. The function of calculating the relative positional relationship is provided generally as software; “3D-DCM (trade name)” of British company “D. Cubed” is an example of such software. Hereinafter, such software may be called “geometrical constraint processing library.” Specifically, a local coordinate system peculiar to each part is set for each part and the relative positional relationship is represented in the form of a transformation matrix between the local coordinate system and a world coordinate system fixed to the space where the assembly model is to be generated. That is, the transformation matrix representing the positions of the parts 1, 2, and 3 from the part relationships 12, 13, 14, and 15 shown in FIG. 5 is automatically calculated by the geometrical constraint processing library.

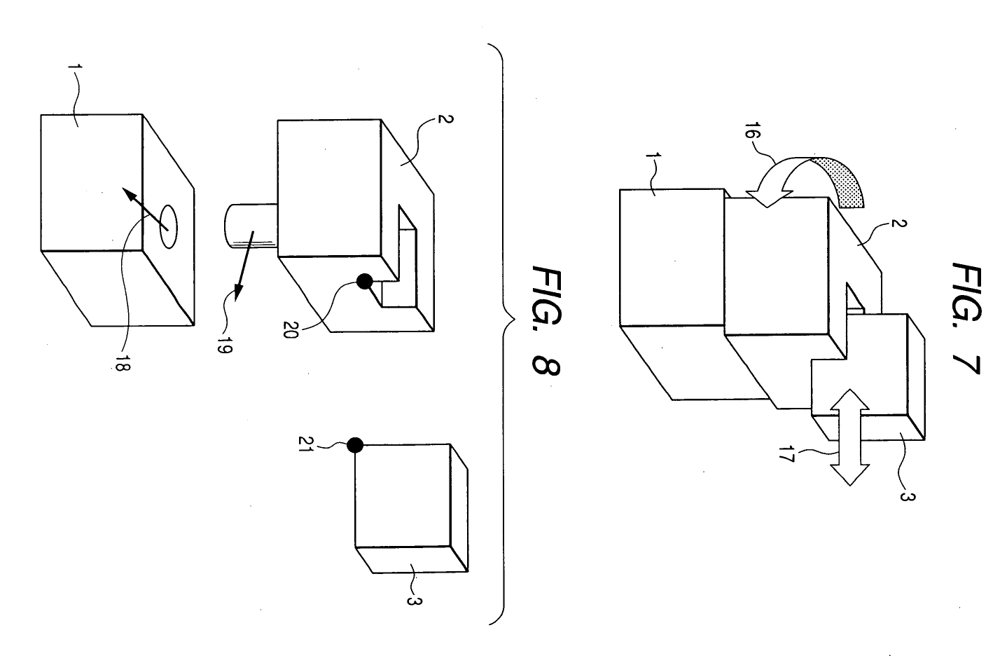

Processing of the geometrical constraint processing library will be discussed in more detail using a two-dimensional simple example. As shown in FIG. 6, a part 102 and a part 103 exist in the space indicated by a world coordinate system 101. Now, matching a line 104 of a geometric feature of the part 102 and a line 105 of a geometric feature of the part 103 with each other and calculating the positions of the parts 102 and 103 will be discussed. First, in the local coordinate system of the part 102, the line 104 is represented as the following Expression (1).

a₁(x−x₁)+b₁(y−y₁)=0 (1)

In the local coordinate system of the part 103, the line 105 is represented as the following Expression (2).

a₂(x−x₂)+b₂(y−y₂)=0 (2)

Assume that a transformation matrix from the world coordinate system indicating the position of the part 102 to the local coordinate system of the part 102 is represented as the following Expression (3) and that a transformation matrix from the world coordinate system to the part 103 is represented as the following Expression (4).

$$\begin{matrix}( \begin{matrix}cos {θ}_{1} & - sin {θ}_{1} & {α}_{1} \\ sin {θ}_{1} & cos {θ}_{1} & {β}_{1} \\ 0 & 0 & 1\end{matrix} ) & ( 3 ) \\ ( \begin{matrix}cos {θ}_{2} & - sin {θ}_{2} & {α}_{2} \\ sin {θ}_{2} & cos {θ}_{2} & {β}_{2} \\ 0 & 0 & 1\end{matrix} ) & ( 4 )\end{matrix}$$

At this time, assuming that the equation in the world coordinate system of the line 104 is represented as the following Expression (5) and that the equation in the world coordinate system of the line 105 is represented as the following Expression (6), the relationships are represented as the following simultaneous Equations (7), (8), (9) and (10).

a_{1w}(x−x_{1w})+b_{1w}(y−y_{1w})=0 (5)

a_{2w}(x−x_{2w})+b_{2w}(y−y_{2w})=0 (6)

$$\begin{matrix}( \begin{matrix}{x}_{1 w} \\ {y}_{1 w} \\ 1\end{matrix} ) = ( \begin{matrix}cos {θ}_{1} & - sin {θ}_{1} & {α}_{1} \\ sin {θ}_{1} & cos {θ}_{1} & {β}_{1} \\ 0 & 0 & 1\end{matrix} ) ( \begin{matrix}{x}_{1} \\ {y}_{1} \\ 1\end{matrix} ) & ( 7 ) \\ ( \begin{matrix}{a}_{1 w} \\ {b}_{1 w}\end{matrix} ) = ( \begin{matrix}cos {θ}_{1} & - sin {θ}_{1} \\ sin {θ}_{1} & cos {θ}_{1}\end{matrix} ) ( \begin{matrix}{a}_{1} \\ {b}_{1}\end{matrix} ) & ( 8 ) \\ ( \begin{matrix}{x}_{2 w} \\ {y}_{2 w} \\ 1\end{matrix} ) = ( \begin{matrix}cos {θ}_{2} & - sin {θ}_{2} & {α}_{2} \\ sin {θ}_{2} & cos {θ}_{2} & {β}_{2} \\ 0 & 0 & 1\end{matrix} ) ( \begin{matrix}{x}_{2} \\ {y}_{2} \\ 1\end{matrix} ) & ( 9 ) \\ ( \begin{matrix}{a}_{2 w} \\ {b}_{2 w}\end{matrix} ) = ( \begin{matrix}cos {θ}_{2} & - sin {θ}_{2} \\ sin {θ}_{2} & cos {θ}_{2}\end{matrix} ) ( \begin{matrix}{a}_{2} \\ {b}_{2}\end{matrix} ) & ( 10 )\end{matrix}$$

On the other hand, the condition that two lines match is equivalent to the two geometrical conditions:

(1) one point on one line is on the other line; and
(2) direction vectors are parallel (outer product is 0).

This is represented in the world coordinate system as represented in the following Equation (11).

$$\{ \begin{matrix}{a}_{1 w} ( {x}_{2 w} - {x}_{1 w} ) + {b}_{1 w} ( {y}_{2 w} - {y}_{1 w} ) = 0 \\ {a}_{1 w} {b}_{2 w} - {b}_{1 w} {a}_{2 w} = 0\end{matrix} \qquad ( 11 )$$

The condition is added and the equation is solved, whereby the positions of the parts 102 and 103 satisfying the match condition of the lines 104 and 105 are calculated. If sin θ and cos θ are set to s and c for convenience of solving the equation, the following quadratic simultaneous Equations (12), (13), (14), (15), (16) and (17).

$$\begin{matrix}\{ \begin{matrix}{a}_{1 w} ( {x}_{2 w} - {x}_{1 w} ) + {b}_{1 w} ( {y}_{2 w} - {y}_{1 w} ) = 0 \\ {a}_{1 w} {b}_{2 w} - {b}_{1 w} {a}_{2 w} = 0\end{matrix} & ( 12 ) \\ ( \begin{matrix}{x}_{1 w} \\ {y}_{1 w} \\ 1\end{matrix} ) = ( \begin{matrix}{c}_{1} & - {s}_{1} & {α}_{1} \\ {s}_{1} & {c}_{1} & {β}_{1} \\ 0 & 0 & 1\end{matrix} ) ( \begin{matrix}{x}_{1} \\ {y}_{1} \\ 1\end{matrix} ) & ( 13 ) \\ ( \begin{matrix}{a}_{1 w} \\ {b}_{1 w}\end{matrix} ) = ( \begin{matrix}{c}_{1} & - {s}_{1} \\ {s}_{1} & {c}_{1}\end{matrix} ) ( \begin{matrix}{a}_{1} \\ {b}_{1}\end{matrix} ) & ( 14 ) \\ ( \begin{matrix}{x}_{2 w} \\ {y}_{2 w} \\ 1\end{matrix} ) = ( \begin{matrix}{c}_{2} & - {s}_{2} & {α}_{2} \\ {s}_{2} & {c}_{2} & {β}_{2} \\ 0 & 0 & 1\end{matrix} ) ( \begin{matrix}{x}_{2} \\ {y}_{2} \\ 1\end{matrix} ) & ( 15 ) \\ ( \begin{matrix}{a}_{2 w} \\ {b}_{2 w}\end{matrix} ) = ( \begin{matrix}{c}_{2} & - {s}_{2} \\ {s}_{2} & {c}_{2}\end{matrix} ) ( \begin{matrix}{a}_{2} \\ {b}_{2}\end{matrix} ) & ( 16 ) \\ \{ \begin{matrix}{c}_{1}^{2} + {s}_{1}^{2} = 1 \\ {c}_{2}^{2} + {s}_{2}^{2} = 1\end{matrix} & ( 17 )\end{matrix}$$

The quadratic simultaneous equations include 12 independent expressions and contain eight constants x₁, y₁, x₂, y₂, a₁, b₁, a₂, and b₂ representing the equations of the lines in the local coordinate systems of the lines 104 and 105. The number of variables is 16 and those to be found are parameters c₁, s₁, c₂, s₂, α₁, β₁, α₂, and β₂ indicating the positions of the parts 102 and 103. To find the values of c₁, s₁, c₂, s₂, α₁, β₁, α₂, and β₂, the eight constants x₁, y₁, x₂, y₂, a₁, b₁, a₂, and b₂ and other variables different from the parameters c₁, s₁, c₂, s₂, α₁, β₁, α₂, and β₂ of variables may be erased from the quadratic simultaneous equations. As a method of thus erasing variables, Buchberger algorithm for finding Groebner basis of a polynomial ideal is known and therefore the method may be used to erase unnecessary variables before the values of c₁, s₁, c₂, s₂, α₁, β₁, α₂, and β₂ are found, or the constants of the quadratic simultaneous equations may be assigned for directly solving the equations. In any way, since the number of the variables is larger than the number of expressions by four, it is seen that two degrees of freedom exist as the expression. The expression is defined in the world coordinate system and if notice is taken that attention is focused on the relative positional relationship between the two parts, the position of one part may be fixed. Thus, for example, if the part 102 is fixed and c₁, α₁, and β₁ are constants, the number of the variables is larger than the number of expressions by one and it is seen that the relative degree of freedom is one. To calculate the position of the part 103, one of the values of c₂, s₂, α₂, and β₂ may be determined a constant (fixed to the current value) and other values may be found. Generally, if definition is made in a situation in which the constraint condition cannot be realized (for example, two lines are parallel and vertical), a solution to simultaneous equations does not exist and thus the situation can be detected. Thus, the geometrical constraint processing library again represents the given constraint relationship as an algebraic expression and performs processing.

Referring again to FIG. 5, the description is continued.

FIG. 7 shows an example of the relative positional relationship (assembly model) among the parts calculated so as to all satisfy the match relationship defined among the geometric features of the parts described above, namely, the constraint relationship among the geometric features. The relative positional relationship shown in FIG. 7 indicates the positions of the parts obtained by causing the transformation matrix of automatically calculated parts to act on the shape data of the parts (conversion using the shape data).

As seen in FIG. 7, the assembly model found as described above does not necessarily generally have the constraint relationship to completely determine the relative positional relationship among the parts. For example, if relative rotation 16 is executed between the parts 1 and 2 or if relative parallel move 17 is executed between the parts 2 and 3, still the relationship shown in FIG. 5 is all maintained. That is, the assembly model shown in FIG. 7 has 16 degrees of freedom of rotation and 17 translational degrees of freedom.

On the other hand, in a field of mechanism analysis, etc., motion is described according to parameters for defining the degree of freedom of mechanism. That is, in the example in FIG. 7, the parameters are the two parameters of the rotation angle corresponding to the degree of freedom of rotation of the rotation 16 and the parallel move distance corresponding to the translational degree of freedom of the parallel move 17.

Examples of the geometric features for defining the parameters are as shown in FIG. 8 corresponding to FIG. 4. Numerals 18 and 19 denote lines representing the direction vectors orthogonal to the center axis of the cylindrical surface. It is assumed that the lines 18 and 19 are rigidly connected to the cylindrical surface. If the constraint relationship that the cylinders are coaxial exists, the angle between the lines 18 and 19 is added as a new constraint relationship, whereby the angle becomes a parameter of the degree of freedom of rotation. Therefore, such lines 18 and 19 are elements representing the cylindrical shape or the position attitude and therefore the invention defines the lines 18 and 19 as geometric features.

In FIG. 8, numerals 20 and 21 denote vertexes of the parts 2 and 3. The vertexes 20 and 21 are not geometric features of planes where the constraint relationship that the planes match is already defined, but are also geometrical elements on the planes and relate geometrically or topologically. Thus, under the constraint relationship that the plane 8 of the part 2 and the plane 10 of the part 3 match, the distance between the vertexes 20 and 21 on the same line on the planes is added as a new constraint relationship, whereby the distance becomes a parameter of the translational degree of freedom.

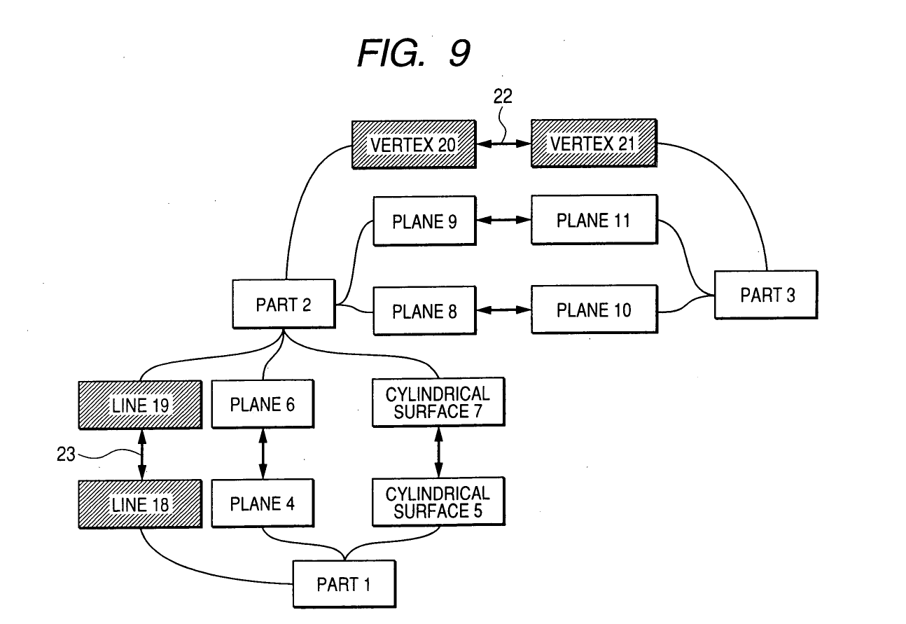

FIG. 9 shows the storage state in the storage when the angle between the lines 18 and 19 and the distance between the vertexes 20 and 21 shown in FIG. 8 are added to the assembly model shown in FIG. 5 as new constraint relationships 22 and 23. As shown in FIG. 9, in addition to the geometric features of the parts and the constraint relationship among the geometric features, the new constraint relationships introduced to define the drive parts of joints, etc., are recorded in the storage.

When kinematics analysis is conducted, the angle between the lines 18 and 19 and the distance between the vertexes 20 and 21 shown in FIG. 8 are related to actuators of motors, etc., whereby such simple mechanism analysis to find motion of the mechanism from change in the actuator parameters (motor angle, etc.,) can also be executed as follows: When the values at a given time are given to the mechanism parameters determined according to the described procedure, the geometrical constraint processing library determines the positions and the attitudes of the parts in a two-dimensional or three-dimensional space and sequentially changes the positions and the attitudes conforming to the time steps. Accordingly, it is made possible to perform work such as checking the motion as the mechanism as simulation.

If two rotation shafts are joined by a gear, the relationship between the angle parameters like the angle between the lines 18 and 19 shown in FIG. 8 may be represented as a primary expression with the gear ratio of the gear as a coefficient. That is, the control target simulator 253 according to the embodiment can also represent the mechanism like a gear as a polynomial and thus processing and operations can be performed integrally using the same method as the method of again representing and handling a given constraint relationship as an algebraic expression by the geometrical constraint processing library. Specifically, the assembly model generation and storage section 204 may add a primary expression with the gear ratio as a coefficient to simultaneous equations and the constraint relationship can be calculated according to the same technique as the technique of calculating the degree of freedom between solids as the degrees of freedom are decreased one as a whole by adding the gear.

According to the assembly model generation method of the assembly model generation and storage section 204 as described above, it is made possible for the control target simulator 253 according to the embodiment to represent a model of the transport mechanism of a manufacturing apparatus or the mechanism of a robot and simulate geometrical motion of the model. The mechanism model data storage section 202 shown in FIG. 1 stores data generated according to the assembly model generation method.

In the invention, further the following processing is performed so as to make it possible to simulate motion of a workpiece to be handled by a transport mechanism or a robot: By way of example, a wafer handled by a robot in a semiconductor manufacturing apparatus is a workpiece to be handled (handling target).

First, the control target simulator 253 according to the embodiment classifies the situation of a workpiece according to what the workpiece is grabbed by, as a robot grabs the workpiece. That is, the workpiece state classification storage section 210 reads a data file in which what state a workpiece can take is previously classified and is stored. Alternatively, the control target simulator 253 inputs the workpiece state using an input machine of a keyboard, a mouse, etc., once retains the input workpiece state as a data file, and reads the data file, thereby storing the data file in the workpiece state classification storage section 210.

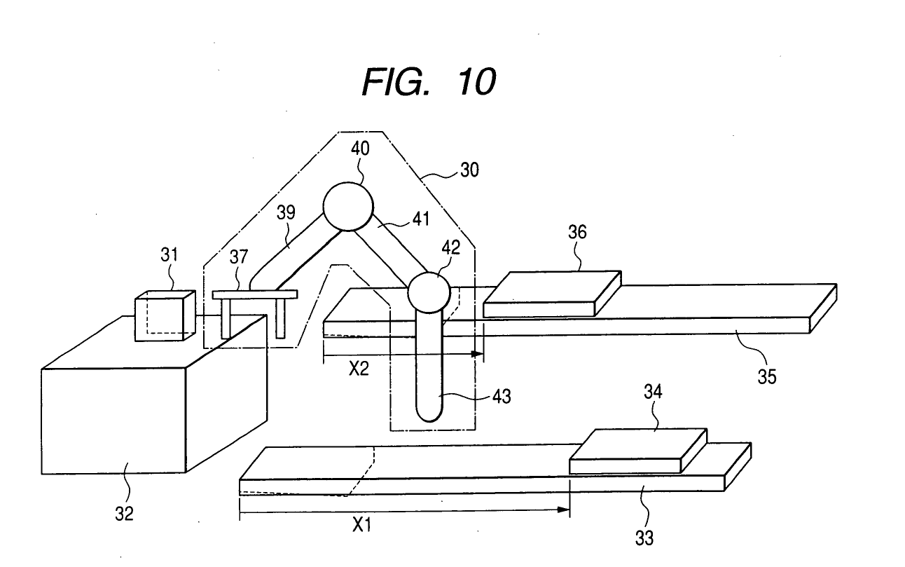

FIG. 10 shows an example of a situation in which an articulated robot 30 handles a workpiece 31 placed on a parts supply bed 32 (the example can be simulated using the control target simulator 253). The robot 30 shown in FIG. 10 is a model having an actuator mechanism including a hand (robot hand) 37, arms 39, 41, and 43, and joint parts 40 and 42. The actuator mechanism is surrounded by parts palettes 34 and 36 each having an appearance shaped like a box, placed side by side roughly in parallel with a floor with a work space of the robot 30 and transport mechanisms 33 and 35 for transporting the parts palettes 34 and 36 from side to side. The arm 43 has one end swivelably supported within the floor and can move along the transport mechanism 33, 35 and further has an opposite end connected pivotably to one end of the arm 41 through the joint part 42. An opposite end of the arm 41 is connected pivotably to one end of the arm 39 through the joint part 40, and the hand 37 for grabbing the workpiece 31 is attached to an opposite end of the arm 39. The joint parts 40 and 42 are driven each by a motor (not shown). Further, an angle sensor made of a variable resistor is attached to each of the joint parts 40 and 42, and each of the joint angle between the arms 39 and 41 and the joint angle between the arms 41 and 43 can be measured by the angle sensor as change in the resistance value and can be detected. In the invention, changing the state when the angle becomes a predetermined value or more is previously described and the magnitude of the angle is previously calculated and acquired according to the positional relationship.

It is assumed that the workpiece 31 is in any of the four states of placement on the parts supply bed 32, placement on the parts pallet 34 or 36, or being grabbed by the hand 37. For example, the workpiece 31 is placed at what position on the parts pallet 36 or the like cannot be determined unless simulation is executed, and thus position information cannot previously be registered. In the example, the fact that the workpiece 31 can take any of the four states is stored in the workpiece state classification storage section 210.

For the four workpiece states stored in the workpiece state classification storage section 210, the control target simulator 253 according to the embodiment further defines transition conditions to the four states. How the transition conditions are represented is described later in detail. For example, a state transition condition is previously defined that “the workpiece 31 makes a transition to the placement state on the parts supply bed 32” at the detection timing of geometrical contact between the parts supply bed 32 and the workpiece 31 of a part. That is, before simulation starts, the four states of the workpiece 31 are enumerated and the transition conditions to the four states are previously defined and at the execution time of the simulation after it starts, which of the four states the workpiece 31 takes and what the positional relationship in the state is are automatically calculated as described later.

Thus, the control target simulator 253 according to the embodiment clearly separates the data to be defined before simulation execution and the data to be automatically calculated at the execution time. Therefore, for example, a machine engineer provides the data to be defined before simulation execution and the control software engineer to check and debug software using the simulation can concentrate on the contents of the control software without trouble of unfamiliar workpiece state setting, etc.

An operation sequence as to how simulation is executed using the data defined before simulation execution will be discussed with reference to FIGS. 10 to 13.

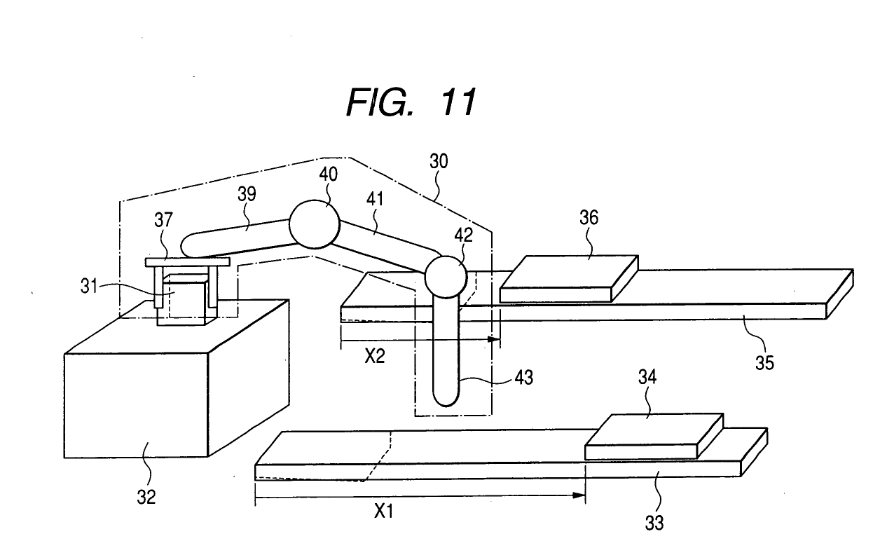

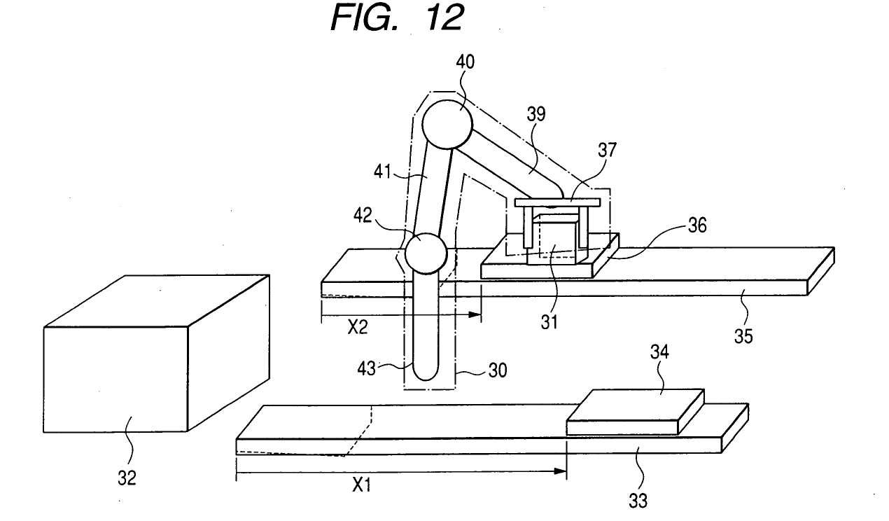

The situation shown in FIG. 10 indicates the initial state where the workpiece 31 is placed on the parts supply bed 32. The robot 30 moves to the position shown in FIG. 11 by command execution for or voltage application to the motors for driving the joint parts 40 and 42 or the like. If a condition is determined that when geometrical interference is detected between the hand 37 and the workpiece 31, the workpiece 31 makes a transition to the state in which it is graphed by the hand 37, the state of the workpiece 31 changes in the situation shown in FIG. 11. Since a state transition is made at the occurrence timing of a geometrical interference detection event between the hand 37 and the workpiece 31, the workpiece relative position calculation section 208 calculates the relative positional relationship with the associated solid (in this case, the hand 37) in the specified state. The positional relationship in a three-dimensional space is represented as a transformation matrix from the local coordinate system of one of the solids between which relationship is defined to the local coordinate system of the other. For three-dimensional solids, the transformation matrix becomes a 4×4 matrix and the positional relationship, which is represented as the transformation matrix from the local coordinate system of the solid to that of the other solid, can be calculated from the transformation matrix from the global coordinate system to the local coordinate system of the solid and from the global coordinate system to the local coordinate system of the other solid. The 4×4 matrix becomes geometrical constraint between the two local coordinate systems and internally is represented as an algebraic expression with the elements of the 4×4 matrix as coefficients as previously described with the example in FIG. 6.

When the workpiece 31 is fixed to the hand 37 by the geometrical constraint relationship corresponding to the 4×4 matrix (is taken into a new coordinate system) and the geometrical constraint or relationship defined between the workpiece 31 and the parts supply bed 32 so far is canceled, the workpiece 31 moves following the motion of the robot 30.

The situation shown in FIG. 12 is a state in which the robot 30 moves and the workpiece 31 moves onto the parts pallet 36. This situation is detected as an event indicating detection of interference check between the workpiece 31 and the parts pallet 36. At this time, the workpiece relative position calculation section 208 calculates the relative position of the workpiece 31 from the parts pallet 36, namely, a transformation matrix from the local coordinate system of the parts pallet 36 to the local coordinate system of the workpiece 31. The geometrical constraint between the workpiece 31 and the hand 37 is canceled, the geometrical constraint between the workpiece 31 and the parts pallet 36 is added, and a transition is made to a state in which the workpiece 31 is placed on the parts pallet 36.

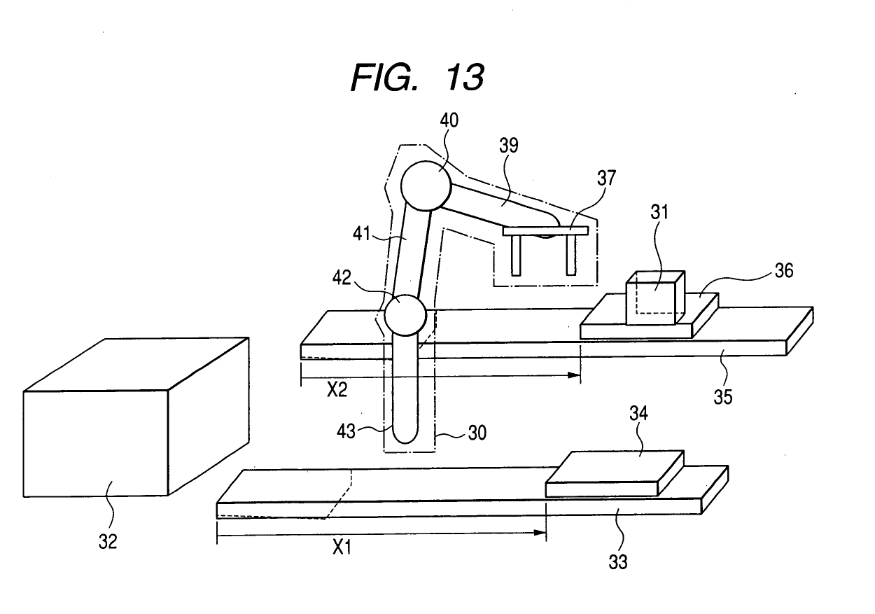

The situation shown in FIG. 13 indicates a state after a further move of the workpiece 31 and the parts pallet 36 in one piece. The workpiece 31 is fixed to the parts pallet 36 because of geometrical constraint and thus moves together with the parts pallet 36.

The simulation is thus executed using the data defined before the simulation execution.

Representation and simulation of the assembly model of a robot, etc., and mechanical modeling in a three-dimensional space (or two-dimensional space) concerning workpiece handling have been described.

### (B) Characteristic Representation of Motor

Next, the characteristic representation of a motor, etc., will be discussed. In modeling of an actuator of a motor, etc., it is important to verify how it behaves on the time base like acceleration, deceleration, etc., and dynamics representation becomes necessary.

The control target simulator 253 according to the embodiment uses a method of representing a system as ordinary differential simultaneous equations using a hybrid modeling language. The specific detailed specifications and the basic concept of the hybrid modeling language are described in detail on a following paper written by the inventor.

“Use of hybrid models for testing and debugging control software for electromechanical systems” (IEEE/ASME Trans. Mechatronics, Vol. 10, No. 3, pp. 275-284).

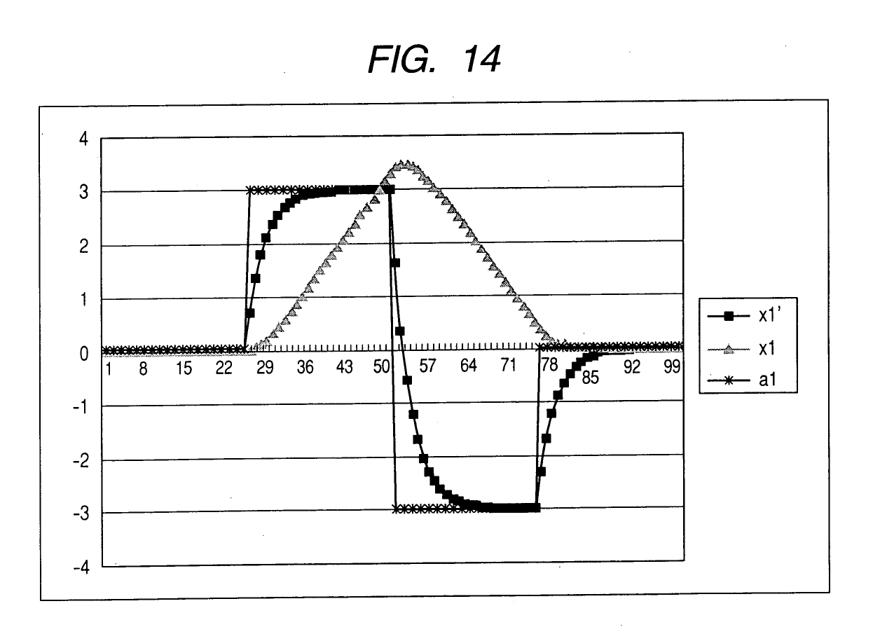

FIG. 14 shows an example of a simple DC motor model and an example of the simulation result of the model using the following Expressions (18) and (19) while switching the use of Expressions (20), (21) and (22).

x₁′=b₁(a₁−x₁″) (18)

b₁=6.0 (19)

a₁=3.0 (20)

a₁=−3.0 (21)

a₁=0.0 (22)

A model is produced as a counter electromotive force occurs on the coil with an increase in the rotation speed of the motor, acceleration is weakened, and the motor rotates at constant speed, and the ordinary differential simultaneous equations as described above are obtained. x₁ represents the motor rotation angle, x₁″ and x₁′ represent second order derivative and first order derivative of x₁, b₁ represents a parameter defining steepness of rising, and a1 represents steady state speed. The three expressions about a1 are switched according to which of normal rotation mode, reverse rotation mode, and stop mode the motor is in.

As another known language for describing a hybrid system, a language of HCC (Hybrid Concurrent Constraint Programming) researched in Palo Alto laboratory of Xerox, in U.S.A., and researched at an extension stage in NASA Ames laboratory, in U.S.A. This is a kind of technology called constraint programming; differential equations and algebraic equations representing a model are considered to be constraints and the equations are described intact not in particular order. A program for controlling the state transition is added to it to complete a model. It is convenient in the point that the equations can be enumerated intact as constraints to produce a program. On the other hand, it is a kind of programming language and although a complicated model can be described, it becomes necessary to understand constraint programming and the language is difficult as a programming language and therefore it is difficult to master the program generation capability.

“Matlab (trade name)”, which is a group of products of MathWorks, are software tools often used by control engineers, etc., as the main users and enable the user to equivalently describe a model represented as a hybrid model. However, for example, differential equations cannot be described intact as a continuous system and it is necessary to analyze the descriptions of the differential equations and again define as a block diagram provided by combining elements such as integration elements.

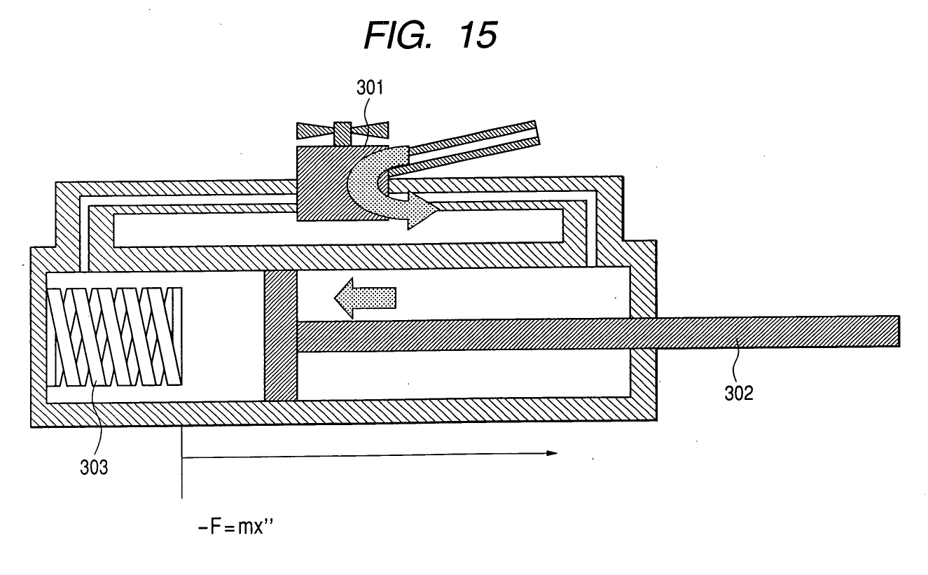

How a hybrid model is input and the result can be output according to the invention will be discussed using a specific example. The example is also simulated using the control target simulator 253 according to the embodiment. To begin with, a simple example will be discussed with reference to FIGS. 15 to 21.

A machine shown in FIG. 15 is a model of a pneumatic actuator including a valve 301, a spring 303, and a piston 302. On a side of an air cylinder, a vent hole for communicating the inside and the outside of the air cylinder is formed at each of left and right parts and the air cylinder main body is provided with the valve 301 having a structure for switching compressed air between left and right air courses for air intake. The piston 302 with a hermetic pressure plate slidable from side to side, fixed to the tip is placed in the air cylinder. The valve 301 allows a compressed air flow to switch to the right (Right) or the left (Left) according to an external command. In the description to follow, Right and Left may be used as the meaning of state, event, or variable.

In the situation shown in FIG. 15, the valve 301 is in the state of Right and thus air from the right air course is supplied to a right chamber formed by the air cylinder and the pressure plate and a left-direction force is exerted on the piston 302. An equation of motion indicating this state is represented by the following Expression (23).

−F=mx″ (23)

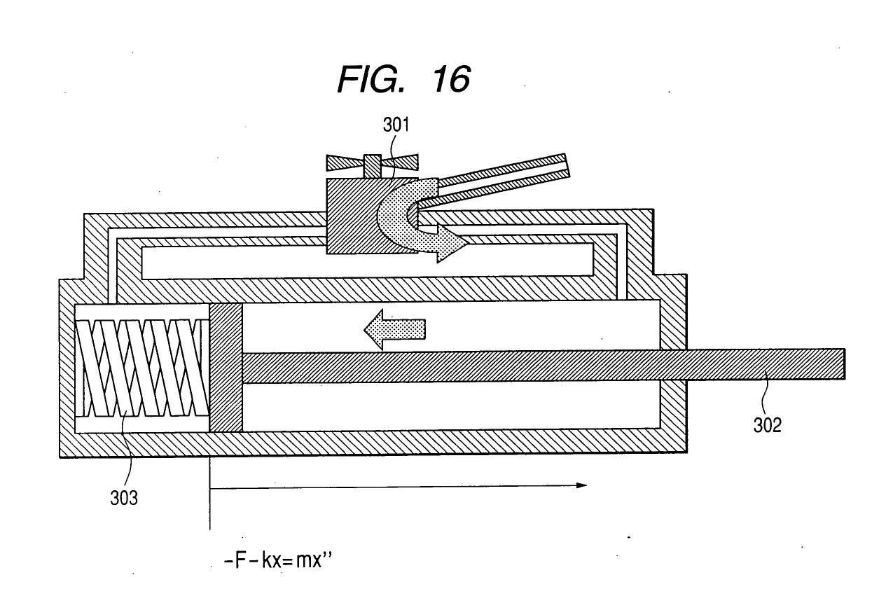

The situation shown in FIG. 16 is a state in which the piston 302 further moves to the left and the pressure plate abuts the spring 303. In this state, a reaction force of the spring 303 occurs and thus the state is described by another Equation (24).

−F−kx=mx″ (24)

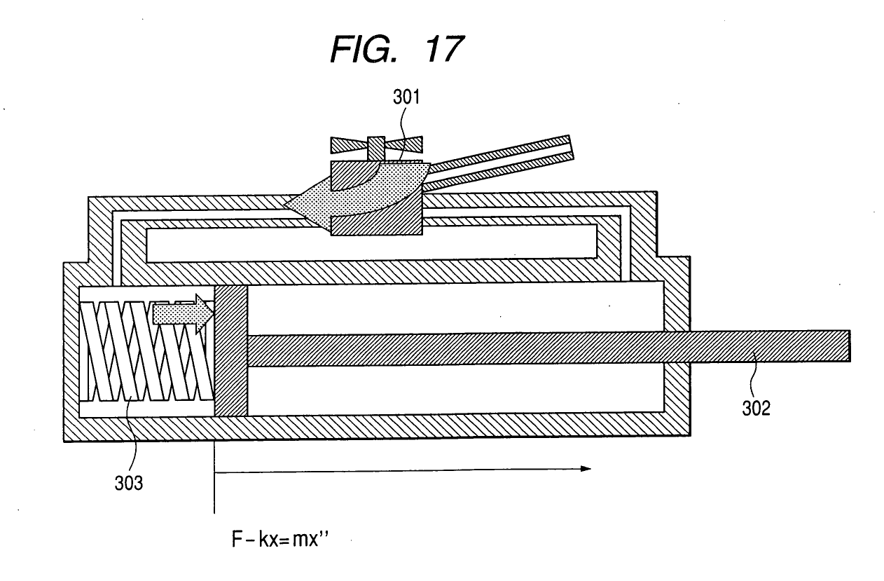

The situation shown in FIG. 17 is a state in which the valve 301 is placed in Left and air from the left air course is supplied to a left chamber formed by the air cylinder and the pressure plate and a right-direction force is exerted on the piston 302. Since the air flow direction changes, a still another equation of motion is used, which is represented by the following Expression (25).

F−kx=mx″ (25)

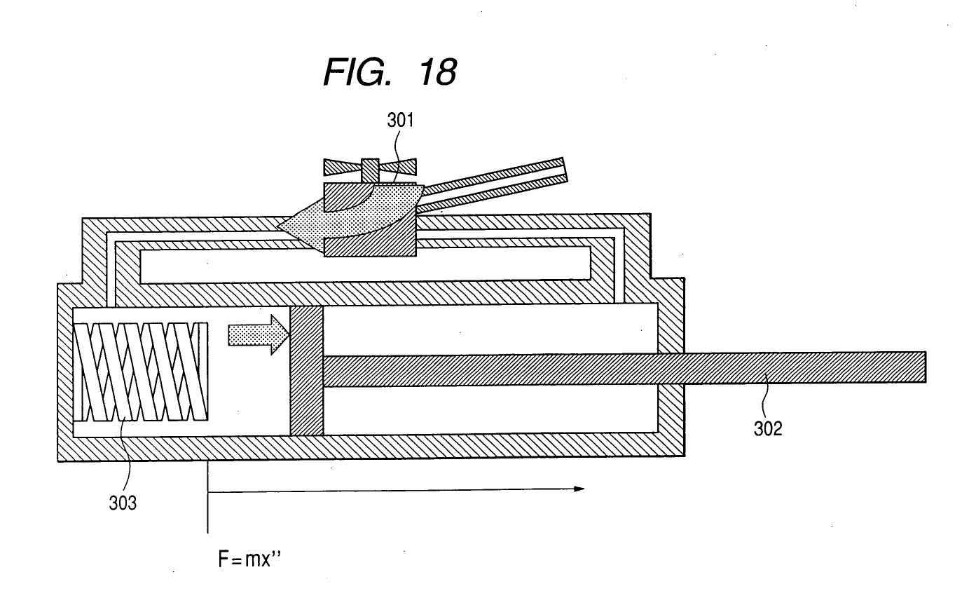

In the situation shown in FIG. 18, the spring force of the compressed spring 303 and the air pressure in the left chamber exceed the air pressure in the right chamber and accordingly the piston 302 moves to the right. This state is a state in which the reaction force from the spring 303 runs out and the state is described by still another equation of motion, which is represented by the following Expression (26).

F=mx″ (26)

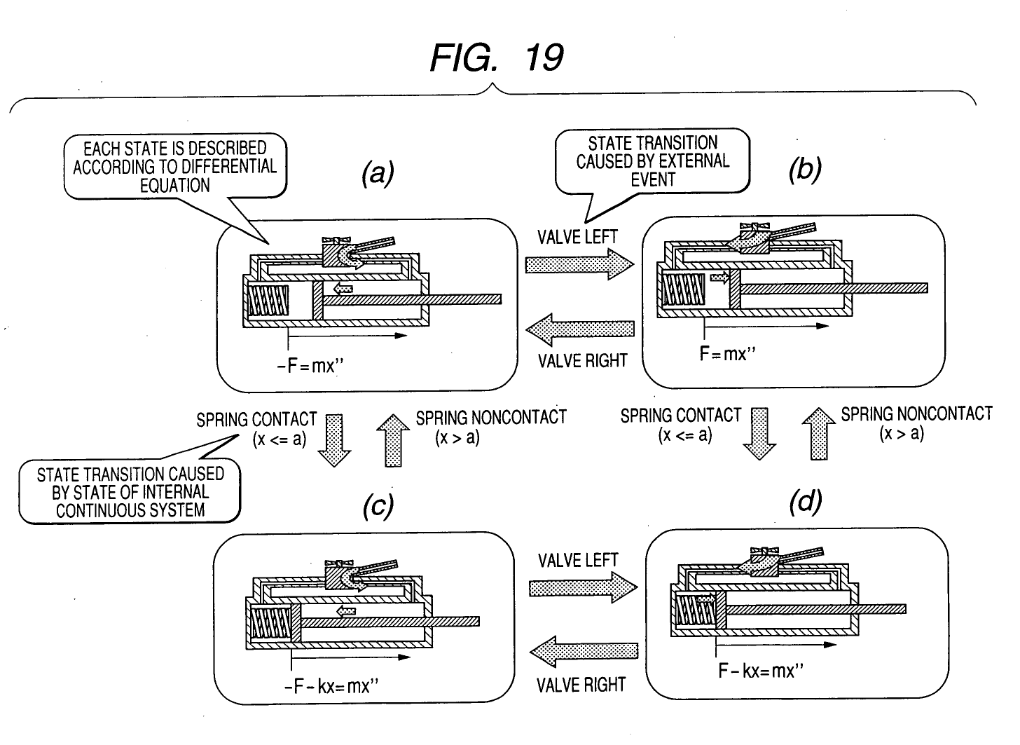

FIG. 19 represents the above-described state change and equations of motion corresponding to the states as a state transition diagram. In the hybrid model, the descriptions of state transition and the states are represented by differential equations and algebraic equations as shown in (a) to (d) of FIG. 19.

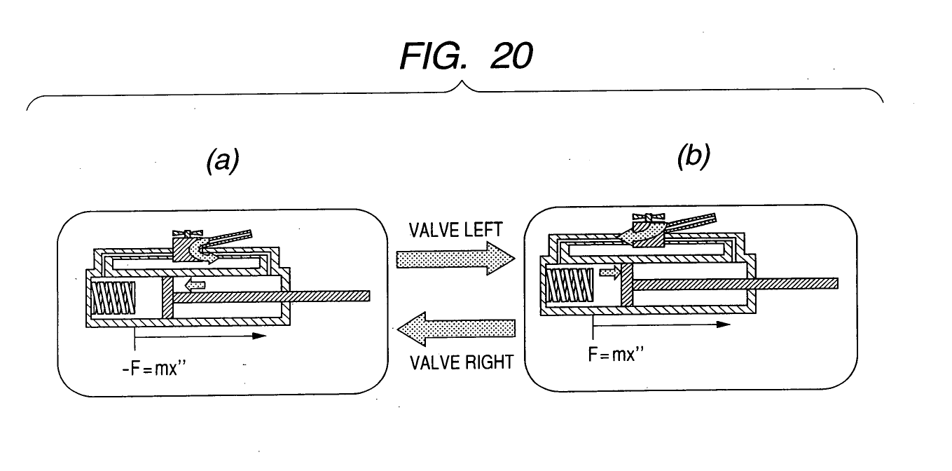

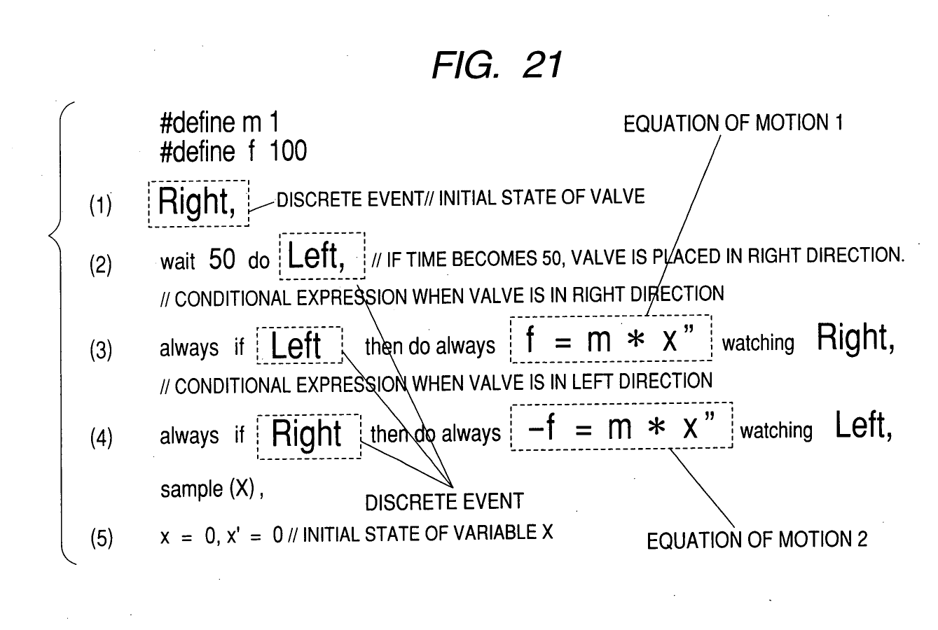

FIG. 20 is a furthermore simplified drawing of the example in FIG. 19. To easily describe how the data input for generation of the state transition diagrams shown in (a) to (d) of FIG. 19 is output to the description of the model, here two states and state transition between the two states are considered. FIG. 21 shows an example of describing the model in FIG. 20 in the HCC. (1), (2), and (5) shown in FIG. 21 describe the operation conditions of the initial state of the machine, the valve operation timing, etc., shown in FIGS. 15 to 18, and (3) and (4) represent the state transition in (a) and (b) in FIG. 20. The equations of motion can be described as they are according to the HCC. The transition condition to each state is described following first “always if”, and the transition condition from each state is described after last “watching.”

In the model described in the hybrid constraint programming language, execution is not necessarily along the program description order (order of (1) to (5) shown in FIG. 21). The program descriptions are searched for the description which holds along the time base of simulation execution and it is executed and thus the order of (1) to (5) does not relate. For example, when simulation is started, only (1) and (5) are effective. At the start time, event Right occurs according to (1) and thus Right of the prerequisite in (4) becomes effective. Therefore, the second equation of motion in (4) becomes effective and simulation is executed as the left state as shown in FIG. 10 (a). In FIG. 21, when the time becomes 50, (2) becomes effective and the equation of motion in (4) becomes ineffective. Instead of (4), the prerequisite in (3) becomes effective and the first equation of motion becomes effective.

### (C) Model in which Transport Mechanism 33, 35 is Driven by Air Actuator

Next, a model in which the transport mechanism 33, in FIG. 11 is driven by the air actuator descried above will be discussed. Such a drive mechanism is often implemented using a motor and ball screws in combination, etc.; a simplified situation is assumed.

Letting the move distances of the transport systems 33 and 34 be x1 and x2, motions of the transport systems 33 and 34 can be represented by rewriting x in the program in FIG. 21 as x1 and x2. For furthermore accurate representation, suffix 1 or 2 indicating either piston is added to variables and events of f, m, Right, Left, etc., in the description.

The mechanism control system 212 (FIG. 1) sends control commands for switching the valve, represented as Right1, Left1 or Right2, Left2 corresponding to the model shown in (a) and (b) in FIG. 20 to the control target simulator 253. Accordingly, the dynamics simulator 205 calculates the side-to-side motion of the piston using differential equations, etc., represented by the control command send timing and model. In the former simulation work, in an offline programming system of a robot, for example, the locus to be followed by the tip position of the hand 37 of the robot is given as a curve and motion along to it is generated. Therefore, the control software design and verification to which the invention is applied differ largely from the former simulation work.

Further, according to the invention, the model of a DC motor, etc., described above is applied to the joint of a robot, whereby the move distances of the piston and the motor are calculated with the passage of time and the move distances are input to the assembly model, whereby simulation of the operation in a three-dimensional space can be executed.

### (D) Workpiece State Transition Condition

The assembly model implementation method, how to handle the handled workpiece, the modeling method based on the hybrid model of the actuator, and the like have been described. Next, the workpiece state transition condition will be discussed in detail.

The workpiece state transition condition is represented by the value of the mechanism model analog sensor (mechanism model analog value sensor), the value of the interference check sensor, the value of the dynamics model variable, and a combination thereof. The mechanism model analog sensor corresponds to measurement of the angle of the specified joint in the assembly model. It corresponds to an example of measuring the angle of a joint using a potentiometer attached to the joint with no motor in a four-joint link mechanism in an actual machine or device as connected to the mechanism control system 212. Simulation based on the assembly model is set to simultaneous algebraic equations containing variables of the measured angle of a joint, etc., and the equations are solved, whereby the mechanism model analog sensor value is found.

To simulate a model having a mechanism for automatically supplying parts every given time, the time may be used as the state transition timing reference. In this case, the operator previously specifies a condition for the control target simulator 253 and then operates the control target simulator 253. That is, in the simulation system according to the embodiment, an attribute that the initial state of the part of a workpiece is not displayed on the display section 211 and is not subjected to interference check with the surroundings of the robot is specified and in addition to the specification of the attribute, the control target simulator 253 is caused to make a state transition under a condition that the part is displayed on the display section 211, on the parts supply bed when a predetermined time is reached after simulation starts. Accordingly, the operation of the machine for handling automatically supplied parts can be simulated.

The time is an indispensable variable or a special variable when dynamics simulation is executed on the time base, and therefore is a built-in reserved variable in the dynamics simulator 205. Therefore, the control target simulator 253 can simulate a condition using the time by using as a variable of the dynamics simulator 205.

A condition may be able to be represented by referencing the value of any desired actuator without using the interference check sensor involving a large calculation cost using the three-dimensional shape of an assembly model. In the example in FIG. 10, etc., the position of the parts pallet 36 can be represented as the move distance x2 of the robot 30 as an actuator. The move distance x2 is a dynamics model variable because it is the move distance of the robot 30.

Further, the barycentric position of the workpiece 31 is the mechanism analog sensor (distance sensor) in the x direction, the y direction, the z direction with the origin of the world coordinate system as one of conditions, whereby it is made possible for the control target simulator 253 to represent the relative positional relationship between the workpiece 31 and the parts pallet 36 and determine whether or not the workpiece 31 is placed on the parts pallet 36.

Further, if a condition that the move speed of the robot 30 or the workpiece 31 is a given value or less is required, the control target simulator 253 references the dynamics model variable. Thus, the invention makes it possible to represent a complicated condition by combining a Boolean expression (OR or AND) with the value of the mechanism model analog sensor, the value of the interference check sensor, and the value of the dynamics model variable in addition to reference to the value of the mechanism model analog sensor, the value of the interference check sensor, and the value of the dynamics model variable. Accordingly, the control target simulator 253 according to the embodiment can represent the state transition condition adapted to the simulation purpose in simulation to verify control software where the timing is important and can also execute simulation containing not only three-dimensional geometrical shape information, but also the descriptions containing time elements. An example of the state transition condition of the simulation system according to the embodiment is as shown in the following Table 1.

TABLE 1
State transition condition
The state transition condition is defined by a sensor check
condition and an AND concatenation condition (type 101)
and an OR concatenation condition (type 102). The sensor
check condition is represented as types 1 to 9:

| | |
|---|---|
| Type 1: | Value of mechanism model analog sensor is |
| | specified value or less |
| Type 2: | Value of mechanism model analog sensor is |
| | specified value or more |
| Type 3: | Value of mechanism model analog sensor is |
| | specified value or more and specified value or |
| | less |
| Type 4: | Mechanism model interference check sensor is |
| | on or off |
| Type 5: | Value of dynamics model variable is specified |
| | value or less |
| Type 6: | Value of dynamics model variable is specified |
| | value or more |
| Type 7: | Value of dynamics model variable is specified |
| | value or more and specified value or less |
| Type 8: | Simulation time (special variable in dynamics |
| | model) is specified value or later |
| Type 9: | Specified workpiece is in specified state |

Each of the sensor check conditions of types 1 to 9 is a single condition of referencing the value of the mechanism model analog sensor, the interference check sensor, or the value of the dynamics model variable. Each sensor check condition functions as a transition condition element. In addition to the sensor check conditions, the control target simulator 253 according to the embodiment defines an AND concatenation condition and an OR concatenation condition of one or two or more sensor check conditions and represents the state transition condition using a tree structure.

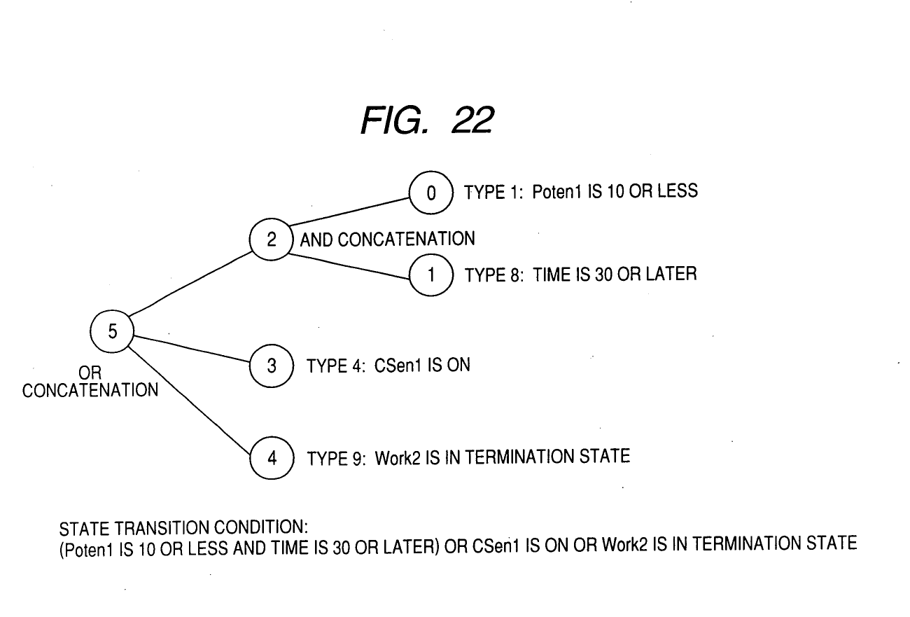

The state transition condition is represented by six elements of elements 0 to 5 as shown in FIG. 22. Element 0 is reference processing to the mechanism model analog sensor represented as Poten1 and the control target simulator 253 defines that variable Poten1 is 10 or less (type 1). Element 3 is check as to whether the interference check sensor is on or off and the control target simulator 253 defines that variable CSen1 goes on. The control target simulator 253 can describe a situation in which another workpiece is supplied when processing of one workpiece terminates, for example, by specifying the workpiece state as variable Work2 is in termination state (type 9) like element 4.

The workpiece state classification storage section 210 of the control target simulator 253 previously reads a plurality of states that a workpiece can take from the workpiece state and attribute data storage section 213 and defines the state transition condition to make a transition to any of the states as (Poten1 is 10 or less and the time is 30 or later) or (CSen1 is on) or (Work2 is in termination state) and stores the state transition condition in the workpiece state classification storage section 210 as attribute data. In other words, the attribute data is data of each of elements 0 to 5 or a combination of the elements.

In more detail, the state transition event detection section 209 determines whether or not the element that Poten1 is 10 or less holds by the reference result to the mechanism model analog sensor. The state transition event detection section 209 determines whether or not the element that the time is 30 or later holds by referencing the variable of the dynamics simulator 205. The state transition event detection section 209 determines whether or not the element that CSen1 is on holds by the value of the interference check sensor. The state transition event detection section 209 determines whether or not the element that Work2 is in termination state holds by referencing the workpiece state classification storage section 210. The state transition event detection section 209 determines whether or not the state transition condition of a combination of the four elements holds. The state transition event detection section 209 determines occurrence of an event at the timing at which the state transition condition holds, and recognizes that the state makes a transition. Thus, the state transition event detection section 209 gives a change command of the solid associated with the workpiece.

For example, if a transition is made from a state in which the hand 37 grabs the workpiece 31 to a state in which the workpiece 31 is placed on the transport mechanism 33, the state transition event detection section 209 stops interference check processing between the workpiece 31 and the transport mechanism 33 and stops display of interference check. Accordingly, redundant calculation processing required for the interference check is skipped, so that calculation processing can be speeded up.

As described above, the workpiece handling simulation method of the invention enables the control software engineer to connect the control software to the simulator according to the same procedure as connecting to an actual machine and verify the control software. It also makes it possible to simulate a machine system containing workpiece handling while ensuring the convenience.

In a development field, for a prototype of a product containing workpiece handling and the control board 252, it requires a considerable time from design data to completion of the prototype. The invention enables the control software developer to simulate the product based on the design data concurrently during trial production of the prototype, so that backtracking of the design does not occur.

It is to be understood that the invention is not limited to the specific embodiment described above and that the present invention can be embodied with the components modified without departing from the spirit and scope of the invention. For example, in the simulation model described above, the internal state of the dynamics mode is switched between the two types in response to the air flow direction in the pneumatic actuator, but it can also be made possible to select the internal state from among three types or more in response to the model. Although the workpiece state classification storage section 210 stores the four workpiece states, two, three, or five or more workpiece states can also be stored. The input section 251 and the control board 252 are formed separately, but may be formed in one piece. The mechanism model data storage section 202, the dynamics model data storage section 203, and the workpiece state and attribute data storage section 213 can be formed as the same storage or different storage or may be formed using various storage media provided outside the control target simulator 253. The transition condition is determined using Boolean expressions in combination, but various logical conditions can be used as another condition is added.

The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. A simulation apparatus for verifying a control program used for controlling a machine available with workpiece handling operation by simulating the machine, the apparatus comprising:
a dynamics model data storage section that stores dynamics model data of the machine;
an assembly model data storage section that stores assembly model data about a mechanism model of the machine;
a workpiece state data storage section that stores a plurality of pieces of workpiece state data associating each of a plurality of workpiece states with a solid, and transition condition data representing a transition condition among the workpiece states;
a dynamics simulator that executes dynamics simulation over time based on the dynamics model data in accordance with a control command output from the control program;
a state transition event detection section that detects occurrence of a workpiece state transition event;
a relative position calculation section that calculates positional relationship data representing the relative positional relationship between the workpiece state of the workpiece and the solid associated with the workpiece state at a time when a state transition event occurs based on the plurality of pieces of workpiece state data; and
a constraint relationship data generation section that generates data representing the workpiece constraint relationship based on the positional relationship data and the assembly model data.

2. The apparatus according to claim 1 further comprising:
a mechanism model data acquisition section that acquires data of the mechanism model;
an interference presence/absence determination section that determines the presence or absence of interference between the machine and a substance; and
a dynamics model variable acquisition section that acquires a variable of a dynamics model of the machine,
wherein the state transition event detection section detects the state transition event using at least one of the data of the mechanism model, the presence or absence of interference, and the variable of the dynamics model.

3. The apparatus according to claim 2, wherein the state transition event detection section detects the state transition event based on logical conditions of the data of the mechanism model, the presence or absence of interference, and the variable of the dynamics model.

4. The apparatus according to claim 1, wherein the dynamics simulator is configured so as to execute the dynamics simulation in accordance with a plurality of dynamics models of the machine described as a hybrid model, and
wherein the dynamics simulator switches the plurality of dynamics models when occurrence of the state transition event is detected.

5. A simulation method for verifying a control program used for controlling a machine available with workpiece handling operation by simulating the machine, the method comprising:
reading assembly model data about a mechanism model of the machine, dynamics model data of the machine, a plurality of pieces of workpiece state data associating a plurality of workpiece states and a solid with each other, and transition condition data representing a transition condition among the workpiece states;
reading a control command from the control program;
executing dynamics simulation based on the dynamics model data;
determining occurrence of a workpiece state transition event based on data of the mechanism model, data to determine the presence or absence of interference between the machine and a substance, and a variable of a dynamics model of the machine;
calculating positional relationship data representing the relative positional relationship between the workpiece state of the workpiece and the solid associated with the workpiece state at the occurrence time of the state transition event, when a state transition event occurs; and
generating data representing the workpiece constraint relationship based on the positional relationship data and the assembly model data.

6. The method according to claim 5 further comprising determining occurrence of the state transition event by determining the presence or absence of switching to any one of dynamics models of the machine described as a hybrid model

7. The method according to claim 5 further comprising determining occurrence of the state transition event by evaluating logical conditions of the data of the mechanism model, the determination result of the presence or absence of interference, and the variable of the dynamics model.

8. A computer readable medium storing a program causing a computer to execute a process for verifying a control program used for controlling a machine available with workpiece handling operation by simulating the machine, the process comprising:
reading assembly model data about a mechanism model of the machine, dynamics model data of the machine, a plurality of pieces of workpiece state data associating a plurality of workpiece states and a solid with each other, and transition condition data representing a transition condition among the workpiece states;
reading a control command from the control program;
executing dynamics simulation based on the dynamics model data;
determining occurrence of a workpiece state transition event based on data of the mechanism model, data to determine the presence or absence of interference between the machine and a substance, and a variable of a dynamics model of the machine;
calculating positional relationship data representing the relative positional relationship between the workpiece state of the workpiece and the solid associated with the workpiece state at the occurrence time of the state transition event, when a state transition event occurs; and
generating data representing the workpiece constraint relationship based on the positional relationship data and the assembly model data.
